(19) United States
(12) Patent Application Publication
(10) Pub. No.: US 2013/0129523 A1
(43) Pub. Date: May 23, 2013

(54) Bimetallic Compressor Wheel and a Method of Manufacture Thereof

(71) Applicant: EcoMotors, Inc., Allen Park, MI (US)

(72) Inventor: Tyler Garrard, Buellton, CA (US)

(73) Assignee: EcoMotors, Inc., Allen Park, MI (US)

(21) Appl. No.: 13/682,775

(22) Filed: Nov. 21, 2012

Related U.S. Application Data
(60) Provisional application No. 61/562,269, filed on Nov. 21, 2011.

(51) Int. Cl. F01D 5/12; B23P 15/00

(52) U.S. Cl. CPC F01D 5/12; B23P 15/006
USPC 416/241 R; 29/527.1; 29/527.5

(57) ABSTRACT

The performance and durability of compressor wheels coupled to turbocharger shafts are at odds with each other in that a higher rotational speed can be accommodated by an aluminum compressor wheel. But, aluminum has a low yield strength which causes the compressor wheel to expand outwardly at high rotational speeds such that the slip fit on the shaft no longer prevents wobble at high rotational speeds. To at least partially address this issue, the compressor wheel has two portions: an inner portion made of steel or titanium that has a relatively higher yield strength and a blade portion made of a lightweight, castable material. The inner portion is manufactured with grabbing features on its periphery, placed in a die, and the blade portion is cast over the grabbing features to yield a compressor wheel of two materials that provides sufficient shaft stiffening without high rotational inertia.

### CROSS-REFERENCE TO RELATED APPLICATIONS

The present application claims priority benefit from U.S. provisional patent application 61/562,269 filed 21 Nov. 2011.

### FIELD

The present disclosure relates to turbochargers and more particularly to compressor wheels of turbochargers.

### BACKGROUND

Compressor wheels are typically fitted onto turbocharger shafts via precision slip fit. The clamping force exerted by a compressor nut on portion of the compressor wheel that fits over the shaft provides stiffening to the shaft to prevent flexing and wobble in the shaft at high rotational speeds. It is desirable to make the compressor wheel of aluminum so that its rotational inertia is lower than if made of steel or titanium. It is also desirable to manufacture the wheel in aluminum to use high-production, low-cost manufacturing techniques like high-pressure die casting. A downside to aluminum is the low yield strength compared to stronger alternative alloys which allow for radial growth of the compressor wheel due to high centrifugal stresses. In addition, aluminum has a high thermal coefficient of expansion. As temperature of the compressor wheel rises, the stiffening that an aluminum compressor wheel can provides to the shaft decreases. It would be desirable to have a compressor wheel with low rotational inertia and high yield strength that can provide the desired stiffening effect over the temperature and speed range encountered in compressor wheels in turbochargers.

### SUMMARY

At least one drawback with compressor wheels made of single material is overcome by a compressor wheel made of two portions: an inner portion that couples to the turbocharger shaft and is made from a material having a relatively higher yield strength and a blade portion that is coupled with the inner portion and that has a relatively lower yield strength. The inner portion provides stiffness to the shaft and resists bending and outward movement at high rotational speeds. The outer portion can be formed by die casting, a relatively inexpensive manufacturing technique. If the material of the inner portion is steel and the blade portion is aluminum, in one non-limiting example, the rotational inertia of the resulting compressor wheel may be increased slightly, but only marginally as the higher density material is centrally located and contributes little to the overall rotational inertia.

A compressor wheel is provided that includes an inner portion formed of a first material having a first yield strength and a blade portion comprised of a second material having a second yield strength. The first yield strength is greater than the second yield strength. The blade portion is die cast onto the inner portion. In one embodiment, the first material is largely steel and the second material is largely aluminum. In one alternative, the first material is largely titanium and the second material is largely aluminum. A body of the inner portion is substantially cylindrical and the inner portion additionally has grabbing features extending outwardly in a roughly radial direction from an outer surface of the cylindrical body. The grabbing features have a greater cross-sectional area at a first radial distance than cross-sectional area a second radial distance; the first radial distance is greater than the second radial distance and the grabbing features are enveloped by the second material. The body of the inner portion defines a bore and the inner portion of the compressor wheel is adapted to slip fit onto a shaft. In one alternative, the body of the inner portion is solid along at least half of its length and the inner portion defines a threaded bore on one end to adapt to a shaft. The grabbing features, in some embodiments, form ridges that may be arranged: circumferentially, radially, helically, or in waves.

In some embodiments, one of the grabbing features is arranged circumferentially on the outer surface of the inner portion; the one grabbing feature has a base proximate the body of the inner portion; the one grabbing feature has first and second lobes displaced outwardly from the base with the first and second lobes having cross sections greater than the cross section of the base.

A turbocharger is disclosed that has a shaft, a turbine wheel coupled to the shaft, and a compressor wheel coupled to the shaft. The compressor wheel includes an inner portion made of a first material having a first thermal coefficient of expansion and a blade portion made of a second material having a second thermal coefficient of expansion. The first thermal coefficient of expansion is less than the second thermal coefficient of expansion. The blade portion is die cast onto the inner portion. In one embodiment, the material of the shaft and the material of the inner portion of the compressor wheel are similar and the compressor wheel is slip fit onto the shaft. Alternatively, the compressor wheel is press fit onto the shaft.

A body of the inner portion is substantially cylindrical and the inner portion additionally has at least one grabbing feature extending outwardly in a roughly radial direction from an outer surface of the cylindrical body and arranged circumferentially on the outer surface. The grabbing feature has a base located proximate the cylindrical body. The grabbing features further includes a lobe located farther away in a radial direction from the cylindrical body than the base and cross sectional area of the base is less than cross sectional area of the lobe. The grabbing feature is enveloped by the second material in the die casting process.

Also disclosed is a method to manufacture a compressor wheel in which an inner portion of the compressor wheel is cast out of a first material. Alternatively, the compressor wheel is machined. An outer surface of the inner portion has a plurality of grabbing features extending outwardly. The inner portion is placed into a die. A molten second material is injected into the die with the second material contacting the outer surface of the inner portion. The contents of the die are cooled and the die is opened to release contents of the die. The first material has a thermal coefficient of expansion lower than the thermal coefficient of expansion of the second material. The first material has a higher yield strength than the second material.

The grabbing features have a greater cross-sectional area at a first radial distance than at a second radial distance and the first radial distance is greater than the second radial distance.

An advantage of embodiments of the present disclosure is that it allows for low rotational inertia while preventing flexing of the shaft. Furthermore, the complicated portion of the compressor wheel, i.e., the blade portion, can be made out of aluminum, which can be inexpensively produced, while the inner portion, which may be more easily machined out of a material that provides stiffness.

Compressor wheels tend to fail by stress risers at the interface of the shaft and the wheel. By making the compressor wheel side of that interface out of steel or titanium, a tighter fit may be accommodated on the shaft. This partially alleviates this compressor wheel failure mode while also providing additional stiffening support to the turbocharger shaft. Additionally, compressor blades fail at the base of the blades. By providing grabbing features out of a high yield strength material, the base of the blades may be stabilized and that potential failure mode reduced.

### BRIEF DESCRIPTION OF THE DRAWINGS

FIG. 1 is an isometric view of a turbocharger without the housing;

FIG. 2 is an isometric view of a compressor wheel made of a single material;

FIG. 3 is an isometric view of compressor wheel that has two portions, according to an aspect of the present disclosure;

FIG. 3 is a cross section of a blade portion of the compressor wheel of FIG. 3;

FIG. 4 is an isometric view of a cross section of an inner portion of the compressor wheel of FIG. 3;

FIG. 5 is a cross section of the compressor wheel of FIG. 3;

FIG. 6 is a detail of a grabbing feature;

FIG. 7 is a flowchart illustrating one method by which the compressor wheel is manufactured; and

FIG. 8 is a portion of a turbocharger in cross section according to an embodiment of the disclosure.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

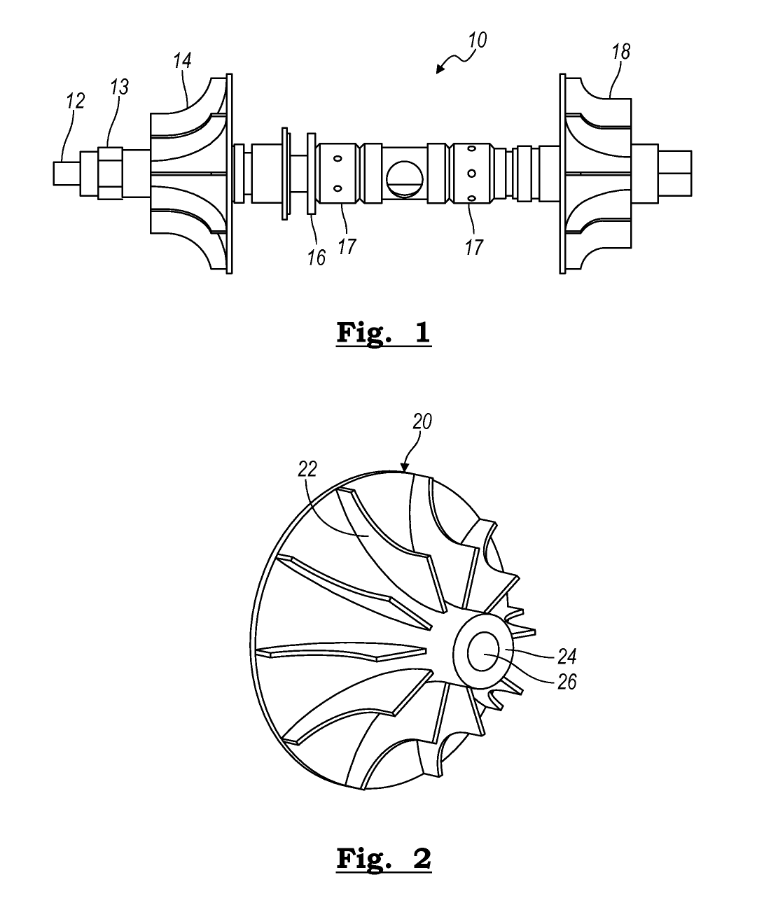

In FIG. 1, the internal components of a turbocharger 10 are shown including a shaft 12 with a compressor net pressing against compressor wheel 14. A washer is included on shaft 12. Bearings 17 are included on the shaft between compressor wheel 14 and a turbine wheel 18.

A standard compressor wheel 20 is shown in FIG. 2 that has a plurality of blades 22, an inner portion 24 that has a bore to slide over the shaft. The compressor wheel may be made of aluminum in a die cast operation. The die cast process is inexpensive. Typically, the shaft is made of steel or titanium to give the desired strength.

In one embodiment, the compressor wheel is precision slip fit onto the shaft. In other alternatives, the compressor wheel is press fit or shrink fit onto the shaft. The tightness of the fit is determined at least by the materials of the shaft and the compressor wheel, the temperature range that is expected to be encountered during operation, the temperature gradients, peak rotational speed, and the stress fractures that can form due to interferences.

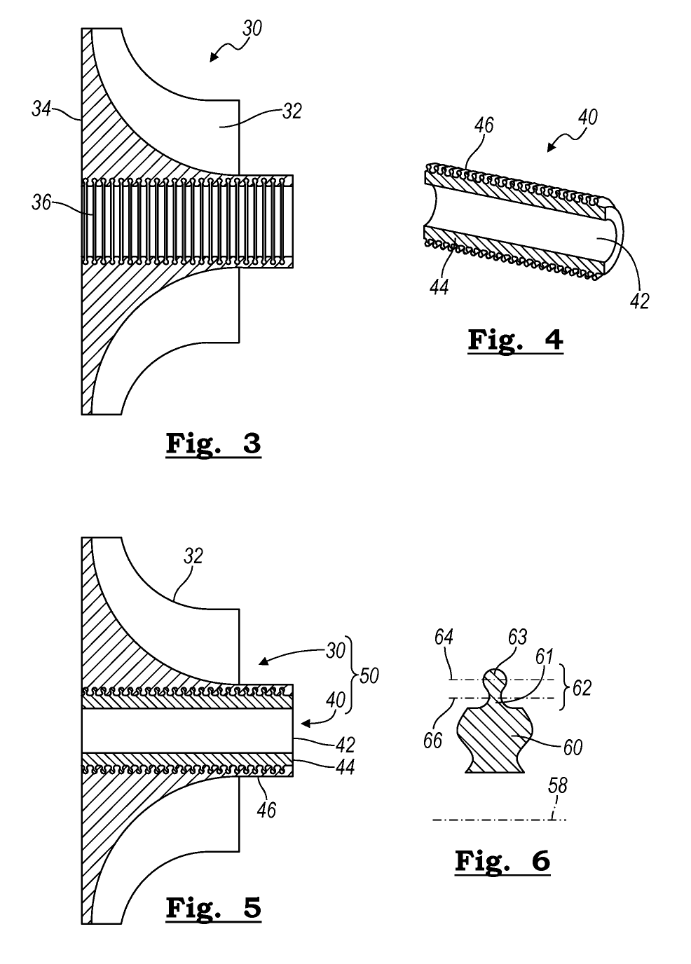

A compressor wheel 50 according to an embodiment of the disclosure is shown in cross section in FIG. 5 with a blade portion 30 illustrated in FIG. 3 and an inner portion 40 illustrated in FIG. 4. Blade portion 30 includes a plurality of blades 32, a root 34, and a plurality of grooves 36.

In FIG. 4, a section of inner portion 40 is shown isometrically. Inner portion 40 has a cylindrical body 44 with grabbing features 46 extending outwardly in a radial direction from body 44. The embodiment of the inner portion in FIG. 4 has a cylindrical bore 42 that is coupled to the turbocharger shaft. In an alternative embodiment, inner portion 40 is solid along at least a portion of the length. A threaded hole may be formed in one end of inner portion 40 to which a threaded end of the shaft can be coupled.

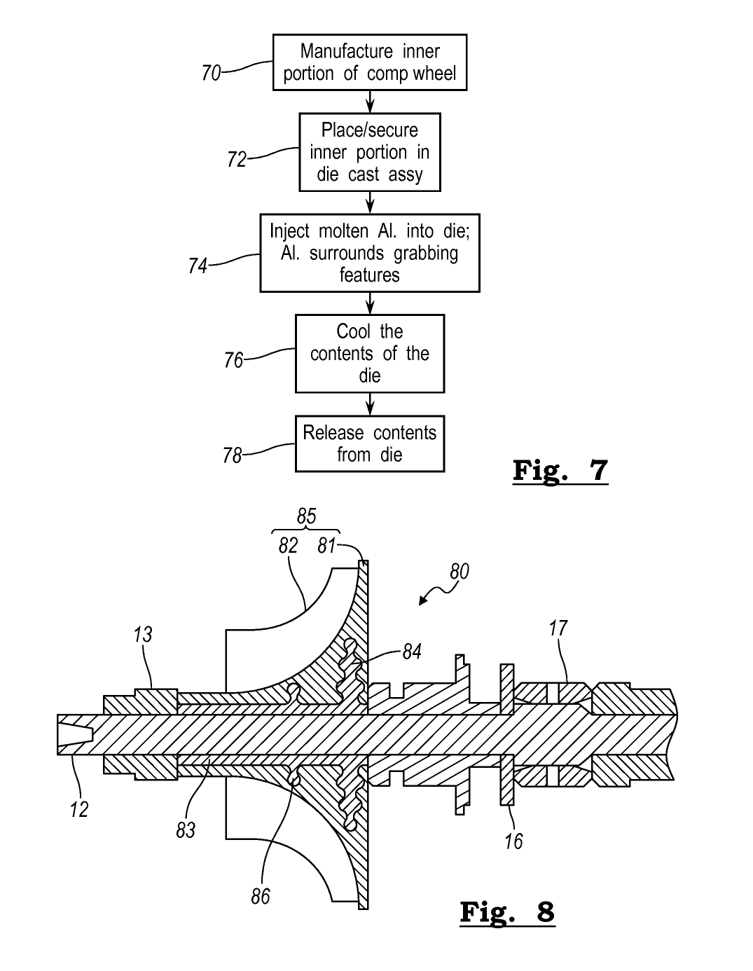

Compressor wheel 50 is shown with inner portion 40 and blade portion 30 assembled. A method of making compressor wheel 50 is described below in reference to FIG. 7.

A detail of a section from an inner portion of a compressor wheel is shown in cross section in FIG. 6. A cylindrical body 60 has a center line 58. A grabbing feature 62 extends outwardly from the outer surface of body 60. Grabbing feature 62 is comprised of a base 61 and a lobe 63. A cross-sectional area of base 61 as taken through plane 66 is less a cross-sectional area of lobe 63 as taken through plane 64.

In the embodiment shown in FIG. 4, grabbing features 46 are actually grabbing ridges that are arranged circumferentially on the outside of body 44. In an alternative, the grabbing features can be ridges arranged axially, helically, or in a wavy pattern, as non-limiting examples. In yet another alternative, the grabbing features are a plurality of individual nubs standing proud of the outer surface of the inner portion of the compressor wheel arranged in any suitable manner. However, to protect the integrity of the joint between the inner and blade portions, cross-sectional area of the grabbing features in the lobe region is greater than cross-sectional area in the base region.

The grabbing features shown in FIGS. 4-6 resemble water towers with a base proximate where the grabbing features connects to the cylindrical body substantially cylindrically shaped and a nearly spherical lobe distal from the cylindrical body. Alternative shapes are contemplated as well, such as having multiple lobes and having shapes with sharper corners.

A method to manufacture a compressor wheel according to the present disclosure is shown in FIG. 7. In block 70, the inner portion of the compressor wheel is manufactured. This may be die cast, machined, forged, or cast using other casting techniques, as a non-exhaustive list of examples. Design of the grabbing feature(s) depends, at least partially, on the technique by which the inner portion is manufactured and how readily various shapes can be formed. The inner portion is secured within a die in a die cast apparatus in block 72. Molten aluminum, or other material, is injected into the die such that the molten material surrounds or envelopes the grabbing features, in block 74. In block 76, the contents of the die are cooled. When sufficiently cooled, the contents of the die, i.e., the bimetallic compressor wheel, is released in block 78.

In FIG. 8, a portion of a turbocharger is shown in cross section. From left to right, shaft 12 has a nut 13, compressor wheel 80, washer 16, and bearing 17. Compressor wheel includes both a blade portion 85 and an inner portion 83. Blade portion 85 includes both a root 81 and a plurality of blades 82. Inner portion 83 has a multi-lobed grabbing feature 84 in a wider portion of the root and a single-lobed grabbing feature 86 within a narrower portion of root 81.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

I claim:

1. A compressor wheel, comprising:
an inner portion comprised of a first material having a first yield strength; and
a blade portion comprised of a second material having a second yield strength wherein the first yield strength is greater than the second yield strength and the blade portion is die cast onto the inner portion.

2. The compressor wheel of claim 1 wherein the first material is largely comprised of steel and the second material is largely comprised of aluminum.

3. The compressor wheel of claim 1 wherein the first material is largely comprised of titanium and the second material is largely comprised of aluminum.

4. The compressor wheel of claim 1 wherein a body of the inner portion is substantially cylindrical and the inner portion additionally has grabbing features extending outwardly in a roughly radial direction from an outer surface of the cylindrical body.

5. The compressor wheel of claim 4 wherein the grabbing features have a greater cross-sectional area at a first radial distance than cross-sectional area a second radial distance; the first radial distance is greater than the second radial distance; and the grabbing features are enveloped by the second material.

6. The compressor wheel of claim 4 wherein the body of the inner portion defines a bore and the inner portion of the compressor wheel is adapted to slip fit onto a shaft.

7. The compressor wheel of claim 4 wherein the body of the inner portion is solid along at least half of its length and the inner portion defines a threaded bore on one end to adapt to a shaft.

8. The compressor wheel of claim 4 wherein the grabbing features form ridges that are arranged one of: circumferentially, radially, helically, and in waves.

9. The compressor wheel of claim 4 wherein:
one of the grabbing features is arranged circumferentially on the outer surface of the inner portion;
the one grabbing feature has a base proximate the body of the inner portion; and
the one grabbing feature has first and second lobes displaced outwardly from the base with the first and second lobes having cross sections greater than the cross section of the base.

10. A turbocharger, comprising:
a shaft;
a turbine wheel coupled to the shaft; and
a compressor wheel coupled to the shaft wherein the compressor wheel is comprised of: an inner portion comprised of a first material having a first thermal coefficient of expansion; and a blade portion comprised of a second material having a second thermal coefficient of expansion; the first thermal coefficient of expansion is less than the second thermal coefficient of expansion; and the blade portion is die cast onto the inner portion.

11. The turbocharger of claim 10 wherein the first material has a higher yield strength than the second material.

12. The turbocharger of claim 10 wherein the material of the shaft and the material of the inner portion of the compressor wheel are similar and the compressor wheel is slip fit onto the shaft.

13. The turbocharger of claim 10 wherein a body of the inner portion is substantially cylindrical and the inner portion additionally has at least one grabbing feature extending outwardly in a roughly radial direction from an outer surface of the cylindrical body and arranged circumferentially on the outer surface.

14. The turbocharger of claim 13 wherein the grabbing feature has a base located proximate the cylindrical body; the grabbing features further includes a lobe located farther away in a radial direction from the cylindrical body than the base; and cross-sectional area of the base is less than cross sectional area of the lobe.

15. The turbocharger of claim 13 wherein the grabbing feature is enveloped by the second material in the die casting process

16. The turbocharger of claim 13 wherein:
the grabbing feature has a base proximate the body of the inner portion;
the grabbing feature has first and second lobes displaced outwardly from the base with the first and second lobes having cross sections greater than the cross section of the base.

17. A method to manufacture a compressor wheel, comprising:
forming an inner portion of the compressor wheel out of a first material wherein an outer surface of the inner portion has a plurality of grabbing features extending outwardly; and the forming comprises one of casting and machining;
placing the inner portion of the compressor wheel into a die;
injecting a molten second material into the die with the second material contacting the outer surface of the inner portion;
cooling contents of the die; and
opening the die to release contents of the die.

18. The method of claim 17 wherein the first material has a thermal coefficient of expansion lower than the thermal coefficient of expansion of the second material.

19. The method of claim 17 wherein the first material has a higher yield strength than the second material.

20. The method of claim 17 wherein the grabbing features have a greater cross-sectional area at a first radial distance than at a second radial distance and the first radial distance is greater than the second radial distance.
